(19) United States
(12) Patent Application Publication
(10) Pub. No.: US 2007/0175048 A1
(43) Pub. Date: Aug. 2, 2007

(54) Medical apparatus for cutting medical tubes

(75) Inventors: Steven Holley, Oxford, MA (US); Amelia Ann Schuchmann, Colleyville, TX (US); Bradley Stewart, Westfield, MA (US); Mark Tauer, Belchertown, MA (US)

Correspondence Address: CARTER, DELUCA, FARRELL & SCHMIDT, LLP, 445 BROAD HOLLOW ROAD, SUITE 225, MELVILLE, NY, 11704, US

(73) Assignee: TycoHealthcare Group LP

(21) Appl. No.: 11/416,061

(22) Filed: May 2, 2006

Related U.S. Application Data
(60) Provisional application No. 60/763,562, filed on Jan. 31, 2006.

(51) Int. Cl. B26B 3/00

(52) U.S. Cl. 30/278

(57) ABSTRACT

A medical apparatus for cutting medical tubes includes a housing member having at least one opening extending through the housing member for receiving a medical tube, and defining a longitudinal axis, a blade member mounted for longitudinal movement relative to the housing member along a blade path from an initial position to an actuated position to traverse the at least one opening and cut the medical tube received therewithin and a biasing member operatively engageable with the blade member and dimensioned to bias the blade member toward the initial position. Preferably, the biasing member is a cantilever member. The cantilever member may be operatively connected to an interior of the housing member and arranged to engage the blade member in supporting relation therewith. First and second cantilever members may extend from opposed interior surfaces of the housing member. The biasing member may include a hinge about which the biasing member pivots during movement of the blade member from the initial position to the actuated position. The hinge may be a living hinge.

### CROSS-REFERENCE TO RELATED APPLICATIONS

This application claims the benefit of and priority to U.S. Provisional Patent Application No. 60/763,562, filed Jan. 31, 2006.

### BACKGROUND

1. Technical Field

The present disclosure relates generally to a medical apparatus. In particular, the present disclosure relates to an apparatus and method for selectively cutting medical tubes.

2. Description of the Prior Art

Medical tubes include sterilized thin and flexible tubes for use in a variety of medical applications. These medical tubes are considered, for example, if a person requires frequent or continued injections of medication or fluids for nutritional support. For example, catheters and other medical tubes are inserted into a patient's cardiovascular system for permitting fluid to pass into or out of the system. In addition, other medical tubes are adapted for expanding a bodily passage or cavity and/or for conveying diagnostic or other instruments, such as, for example, a guidewire. Medical tubes may be permanently placed under the skin or through the skin (e.g. internal catheter or shunt) or, alternatively, may be permitted to protrude out through the skin (e.g. external catheter). Applications in which medical tubes are employed include angiographies, angioplasties, endoscopies and biopsies, blood transfusions, dialysis, nutrition and/or drug delivery.

Although medical tubes provide necessary access, use of the tubes may present a challenge in that the tubes are provided in standard sizes which are often too long for the intended use. Inappropriate size of the catheter may increase the risk of accidental dislodgement and/or severe injury because of movement of the external portion of the catheter. This result may place patients at risk for local and systemic infectious complications, including, for example, local site infection, blood stream infections, and other metastatic infections.

In general, medical tubes are cut using scissors or the like. This method of cutting medical tubes, however, may result in a jagged cut or an angled cut, and may disturb or degrade the integrity of the tube which may result in further patient injury. In addition, the cutting procedure is awkward for the operator. Therefore, there remains a need for precisely and safely cutting medical tubes with minimal disturbance to the structural integrity of the tube.

### SUMMARY

Accordingly, the present disclosure is directed to a medical apparatus for cutting medical tubes. The medical apparatus includes a housing member having at least one opening extending through the housing member for receiving a medical tube, and defining a longitudinal axis, a blade member mounted for longitudinal movement relative to the housing member along a blade path from an initial position to an actuated position to traverse the at least one opening and cut the medical tube received therewithin and a biasing member operatively engageable with the blade member and dimensioned to bias the blade member toward the initial position. Preferably, the biasing member is a cantilever member. The cantilever member may be operatively connected to an interior of the housing member and arranged to engage the blade member in supporting relation therewith. First and second cantilever members may extend from opposed interior surfaces of the housing member. The biasing member may include a hinge about which the biasing member flexes during movement of the blade member from the initial position to the actuated position.

The at least one opening of the housing member may have a first length defined between a front side of the housing member and the blade path, and a second different length defined between a second rear side of the housing member and the blade path. The first and second lengths preferably have predetermined values to facilitate cutting of the tube to a desired tube length. In one embodiment, the first length is about 0.5 cm and the second length is about 1.0 cm.

The housing member may include contoured outer surfaces to facilitate engagement by an operator. Preferably, the housing member includes a plurality of openings having different internal dimensions to accommodate different size medical tubes.

In another preferred embodiment, the medical apparatus includes a handle, a head depending from the handle and defining at least two openings of different internal dimensions for reception of medical tubes having corresponding cross-sectional dimensions, and a blade mounted to the head. The blade is adapted for movement relative to the at least two openings from an initial position to an approximated position upon actuation of the handle to cut a medical tube positioned within one of the at least two openings to a predetermined length.

The handle may include first and second handle portions. The first and second handle portions may be adapted for relative movement to cause movement of the blade between the initial position and the approximated position. The first and second handle portions may be mounted for relative pivotal movement or, alternatively, relative longitudinal movement. The first handle portion may be stationary and the second handle portion may be moveable relative to the first handle portion. The handle may define various arrangements such as a general shear grip arrangement or a general pistol grip arrangement.

The medical apparatus may also include biasing means operatively associated with the handle for biasing the blade towards the initial position.

In another preferred embodiment, the medical apparatus for cutting medical tubes includes a first member including at least one passage defining an internal dimension adapted for reception of a medical tube having a generally corresponding cross-sectional dimension and a second member operatively connected to the first member. The second member carries a blade member positioned to traverse the at least one passage of the first member upon relative movement of the first and second members from an initial position to an actuated position to cause the blade member to sever the medical tube to a predetermined length thereof. The first member may include at least two openings extending therethrough defining different internal dimensions. The at least two openings are each adapted for reception of a medical tube having a corresponding cross-sectional dimension. Alternatively, the at least one opening is a recess defined in an outer surface of the first member.

The first and second members are adapted for pivotal movement between the initial position and the actuated position. Alternatively, the first and second members are adapted for relative longitudinal movement between the initial position and the actuated position.

### BRIEF DESCRIPTION OF THE DRAWINGS

The features of the presently disclosed medical apparatus for cutting medical tubes will become more readily apparent by referring to the following detailed description of embodiments, which are described hereinbelow with reference to the drawings, wherein:

FIG. 1 is a side plan view of a medical apparatus for selectively cutting medical tubes in accordance with the principles of the present disclosure;

FIG. 2 is a perspective view of the medical apparatus illustrating the medical apparatus of FIG. 1 in an actuated position to selectively cut the medical tube;

FIG. 3 is a flow chart illustrating a preferred method of use of the medical apparatus of FIG. 1;

FIG. 4 is a side plan view of an alternate embodiment of the medical apparatus of the present disclosure;

FIG. 5 is a side plan view of an alternate embodiment of the medical apparatus of the present disclosure;

FIG. 6 is a side plan view of another alternate embodiment of the medical apparatus of the present disclosure;

FIG. 7 is a side plan view of another alternate embodiment of the medical apparatus of the present disclosure;

FIG. 8 is a side plan view of another alternate embodiment of the medical apparatus of the present disclosure;

FIGS. 9-10 are perspective views of another alternate embodiment of the medical apparatus of the present disclosure;

FIG. 11 is a perspective view with parts separated of the medical apparatus of FIGS. 9-10;

FIG. 12 is a side plan view of the medical apparatus with the front cover removed illustrating the blade in an initial position;

FIG. 13 is a side plan view of the medical apparatus with the front cover removed illustrating the blade in an actuated position;

FIG. 14 is a top plan view of the medical apparatus;

FIG. 15 is a side cross-sectional view of the medical apparatus taken along lines 15-15 of FIG. 14;

FIG. 16 is a perspective view of another embodiment of the medical apparatus of the present disclosure;

FIG. 17 is a side plan view of the housing member of the medical apparatus of FIG. 16; and

FIG. 18 is a side cross-sectional view of the medical apparatus of FIG. 16 taken along lines 18-18 of FIG. 17.

### DETAILED DESCRIPTION

The medical apparatus of the present disclosure provides the operator, e.g., health care professional, with an apparatus for clearly and precisely cutting medical tubes desirably, leaving a clean straight or linear cut. Moreover, the medical apparatus of the present disclosure provides for a safe and reliable cutting or severing action on the medical tube substantially reducing the potential for accidents. It also allows the health care professional the ability to reliably cut the tube so as to not have to cut the tube again because of an inaccurate first cut.

In the following description, as is traditional, the term “proximal” refers to the portion of the apparatus closest to the operator while the term “distal” refers to the portion of the apparatus remote from the operator. Although the specific focus of this disclosure will be on a preferred method of cutting catheters, it will be noted that catheters are merely representative of a type of medical tube. Other tubes may include flexible cannulas, shunts, guidewires and any other conduit utilized during a medical or surgical procedure.

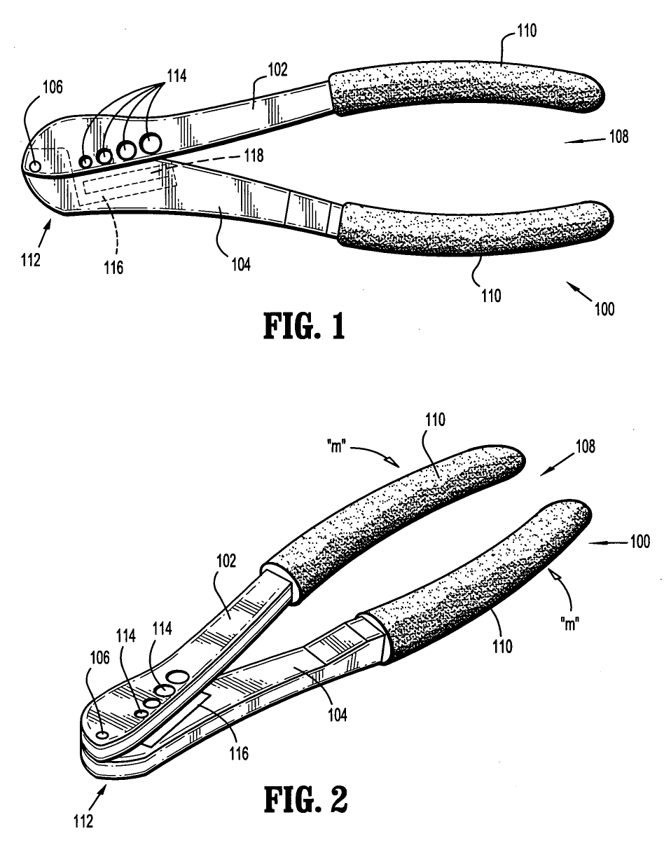

Referring now to the drawing figures, in which like references numerals identify identical or substantially similar elements throughout the several views, various embodiments of the medical apparatus for cutting medical tubes will now be described in detail. With initial reference to FIG. 1, a first embodiment of a medical apparatus for cutting medical tubes in accordance with the present disclosure is illustrated, and is designated generally as medical apparatus 100. Medical apparatus 100 is adapted for use in a system for selectively cutting catheters of various sizes to predetermined lengths. Medical apparatus 100 generally includes first and second elongate members 102, 104 operatively connected to each other and adapted for pivotal movement about pivot pin 106. The proximal ends of elongate members 102, 104 define handle (generally identified as reference numeral 108) adapted for grasping engagement by the operator. Hand grips 110 may be positioned on the elongate members 102, 104 (i.e., adjacent handle 108) for comfort and safety. Hand grips 110 may be manufactured from a thermo shrinkable plastic or elastomeric material. Handle 108 defines a general shear grip configuration as shown.

With continued reference to FIG. 1, first and second elongate members 102, 104 extend to define head portion 112 of apparatus 100. Head portion 112 defines a plurality of openings 114 of various internal dimensions or diameters which extend completely through first elongate member 102. The plurality of openings 114 is adapted for receiving at least one medical tube, such as, for example, a catheter (not shown) therethrough. In the embodiment illustrated in FIG. 1, the plurality of openings 114 each have a circular configuration. However, other configurations of the plurality of openings 114 are also envisioned, such as, for example, oval, conical, tapered, etc. In addition, the margins adjacent each of the plurality of openings 114 may be formed with flanged or tapered areas to facilitate insertion of the catheter tubes.

As noted, openings 114 define different internal dimensions or diameters. In one preferred embodiment, the diameters of openings 114 incrementally increase so as to generally correspond to standard diameter catheter tubes. For example, the diameters of opening 114 may range to include catheters from 3-34 French on the French Catheter scales. A multitude of openings 114 may be provided including more than the four openings shown. Other dimensions are also contemplated.

With continued reference to FIG. 1, head portion 112 further defines blade holding portion or carrier 116 mounted to or integrally formed with second elongate member 104. Blade carrier 116 is dimensioned and configured for receiving blade 118. Blade carrier 116 may be an internally formed recessed wall within second elongate member 104. Alternatively, blade carrier 116 may be a separate mount secured to second elongate member 104 with suitable fixation means such as screws, rivets, adhesives, etc. Blade 118 may be integrally molded into blade carrier 1160 or mounted to blade carrier 116 using adhesive, screws, nuts, and the like. Blade 118 includes a cutting edge for cutting the catheter positioned through at least one opening of the plurality of openings 114.

First and second elongate members 102, 104 are adapted for pivotal relative movement between a first initial position of FIG. 1 where blade 118 of second member 104 is spaced from openings 114 of first elongate member 102 and a second actuated position of FIG. 2 where the blade 118 traverses the openings 114. It is envisioned that first and second elongate members 102, 104 may be normally biased to the first initial position with biasing means (not shown) such as a coil spring, lever spring or the like.

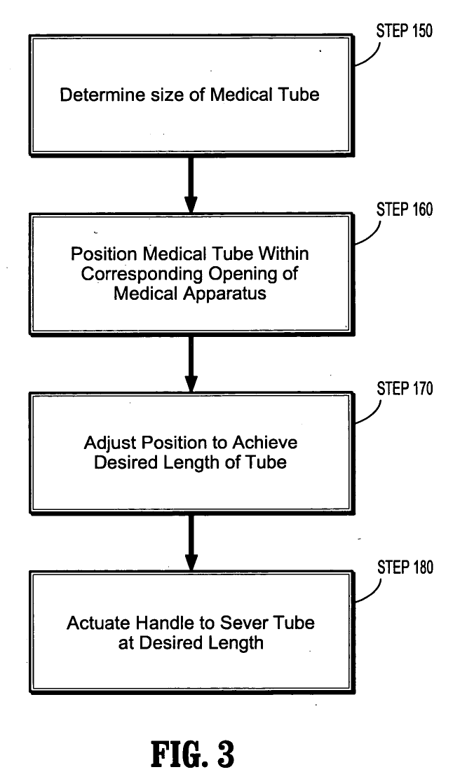

With reference to the flow chart of FIG. 3, a method of use of medical apparatus 100 in cutting medical tubes will now be discussed. Initially, the size of the medical tube is ascertained (STEP 150). Thereafter, the medical tube is introduced within an opening 114 of head portion 112 having a corresponding internal dimension or diameter (STEP 160). The medical tube is advanced or retracted within opening 114 to achieve a predetermined length of the medical tube (STEP 170). Once the desired length is achieved, handle 108 is actuated by moving the proximal ends of elongate members 102, 104 toward each other in the direction of directional arrows “M”. (FIG.2) Such manual manipulation of first and second elongated members 102, 104 causes blade carrier 116 to be displaced towards the plurality of openings 114. Movement of blade carrier 116 will cause blade 118 to move into cutting relationship with the catheter tube. As blade 118 is approximated with respect to openings 114, blade 118 engages and selectively cuts the medical tube (STEP 180). When handle portion 106 is released, first and second elongate members 102, 104 may return to their initial position of FIG. 1 under, e.g., the influence of biasing means, to displace blade 118 from openings 114.

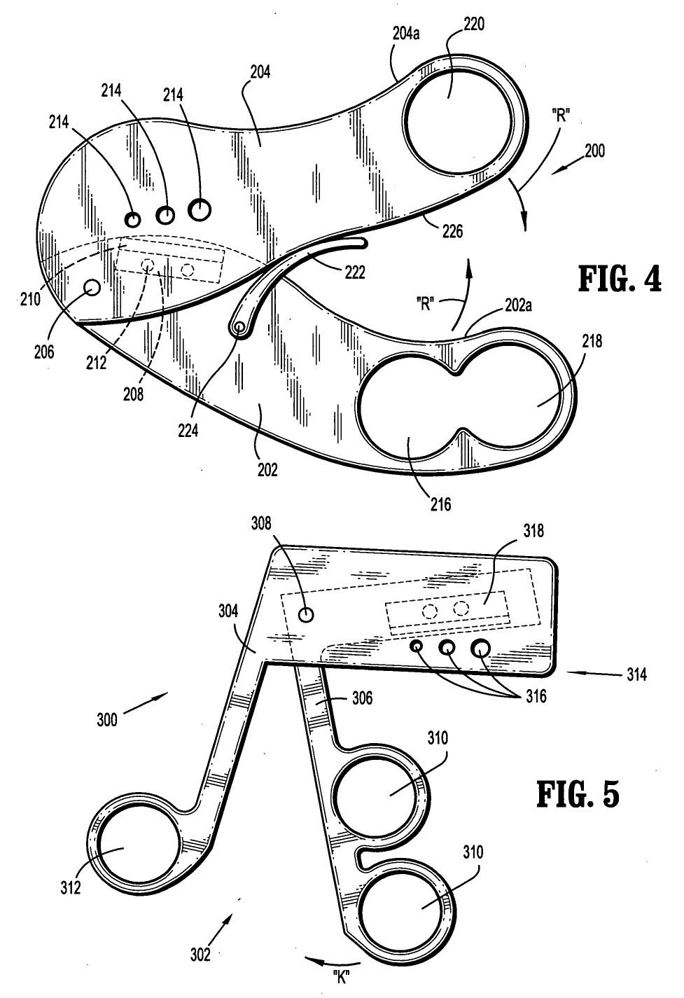

FIG. 4 illustrates an alternate embodiment of the medical apparatus. In accordance with this embodiment, medical apparatus 200 defines a general shear type arrangement with first and second members 202, 204 pivotally connected to each other about pin 206. First member 202 carries blade 208. Blade 208 has sharp edge 210 and is secured to first member 202 by being molded in or with screws, pins, rivets 212 or the like. Second member 204 includes a plurality of openings 214 extending therethrough for reception of a corresponding dimensioned medical tube. First member 202 includes a pair of loops 216, 218 adjacent handle end 202a of the first member 202 for reception of the index and middle fingers respectively of the operator. Second member 204 includes thumb loop 220 adjacent handle end 204a of the second member 204 for receiving the thumb of the user. Medical apparatus 200 further includes leaf spring 222 which is secured at one end to first member 202 by being molded in or via a pin, screw or rivet 224. The free end of leaf spring 222 engages lower surface 226 of second member 204. With this arrangement, leaf spring 222 is adapted to bias the handle ends 202a, 204a of second member 204 away from first member 202, i.e., toward the initial position of medical apparatus 200 depicted in FIG. 3. In other respects, medical apparatus 200 functions in a similar manner to medical apparatus 100 of FIGS. 1-2. In particular, pivotal movement of first and second members 202, 204 about pivot pin 206 in the direction of directional arrows “R” causes blade 208 to traverse openings 214 and cut the medical tube received within one of the openings 214.

Referring now to FIG. 5, an alternate embodiment of the present disclosure is illustrated. Medical apparatus 300 includes handle 302 defining a general pistol grip configuration having stationary handle portion 304 and movable handle portion 306 pivotally mounted to stationary handle portion via pivot pin 308. Movable handle portion 306 includes at least one finger loop 310 for the index and/or middle finger of the operator while stationary handle portion 304 includes thumb loop 312. Loops 310, 312 are advantageously configured for receiving the fingers of an operator for facilitating manipulation and operation of the medical apparatus 300. Stationary and movable handle portions 304, 306 extend to define head portion 314 of apparatus 100. Head portion 314 includes a plurality of openings 316 extending through stationary handle portion 304 and blade mount with mounted blade 318 mounted to or carried by movable handle portion 306. Openings 316 and blade 318 are dimensioned and function in a similar manner to that described hereinabove. In use, the selected medical tube is positioned within a correspondingly dimensioned opening 316 of head portion 314. The operator positions his/her thumb within thumb loop 312 and the index and/or middle fingers through loops 310. Movable handle portion 306 is pivotally moved about pivot pin 308 in the direction of directional arrow “K” to cause blade 318 to move in a downward direction traversing openings 316 and severing the medical tube to the desired length.

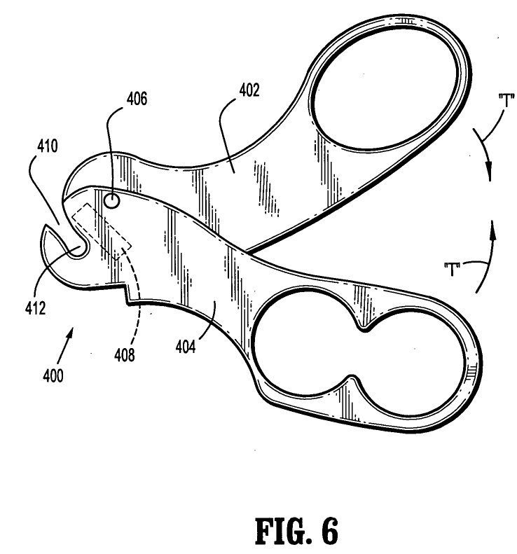

With reference to FIG. 6, another embodiment of the medical apparatus is illustrated. In accordance with this embodiment, apparatus 400 includes first and second members 402,404 pivotally mounted to each other about pivot pin 406. First member 402 carries blade 408. Second member 404 includes a groove, recess or channel 410 in its outer surface which extends inwardly to a relative enlarged opening 412. The medical tube may be passed through recess 410 to be accommodated within opening 412 prior to the cutting action. It is envisioned that opening 412 may be sized to accommodate a large variety of diameter tubes with the internal portions defining the opening 412 containing the tube therewithin. Recess or channel 410 is relatively narrow; however, it is desirably dimensioned to permit the medical tube to flex inwardly sufficient to permit passage into opening 412. As appreciated, by provision of channel 410, the medical tube does not have to be continually fed through opening 412 to the desired location along the tube. Blade 408 mounted to first member 402 may be angulated to the desired orientation to traverse opening 412 during actuation of first and second members 402, 404, i.e., during relative pivotal movement of the first and second members 402,404 in the direction of directional arrows “T”.

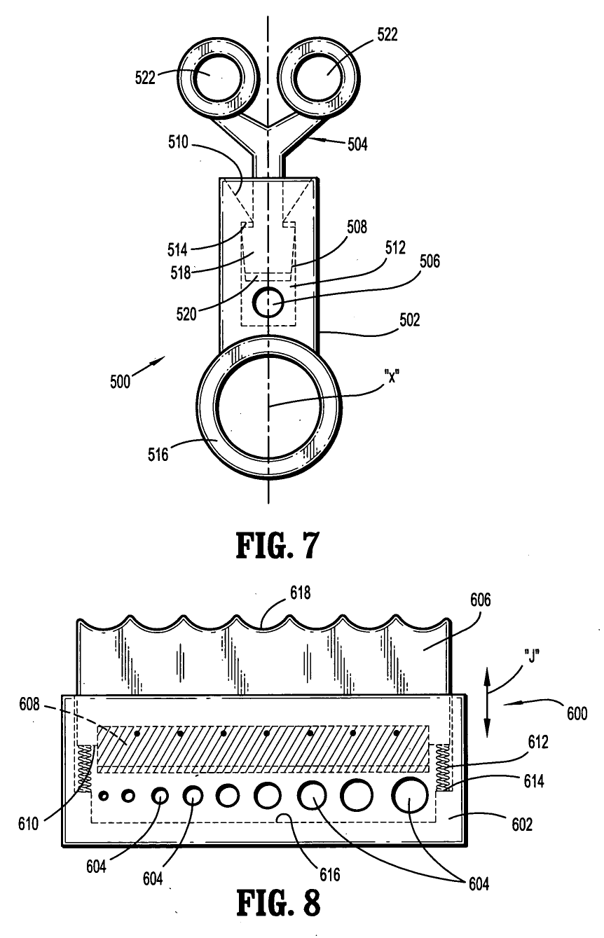

Referring now to FIG. 7, an alternative embodiment of the presently disclosed medical apparatus for cutting medical tubes is illustrated, and is designated generally as medical apparatus 500. Medical apparatus 500 includes housing 502 defining longitudinal axis “x” and blade carrier 504 at least partially received within housing 502. Housing 502 defines at least one opening 506 therethrough for receiving a correspondingly dimensioned catheter tube. Housing 502 may alternatively include a plurality of openings 506 of different dimensions as discussed hereinabove. Housing 502 defines internal channel 508 defining tapered lead in section 510 and cylindrical section 512. At the juncture of tapered and cylindrical sections 510, 512 is internal annular ledge 514. Housing 502 further includes external loop 516 for grasping engagement by the operator, e.g., for receiving a finger of the operator.

Blade carrier 504 defines blade mount 518 having blade 520 affixed thereto by conventional means. Blade carrier 504 also includes at least one external loop 522 for engagement by the operator, e.g., for receiving fingers of the operator. Blade carrier 504 is mounted for longitudinal movement relative to housing 502 from an initial position depicted in FIG. 6 where blade is displaced from the at least one opening 506 to an approximated position where the blade traverses the at least one opening 506. Blade carrier 504 is retained within housing 502 by suitable stop means, such as for example, internal annular ledge 514 within housing 502 which engages blade mount 518. Blade carrier 504 is preferably biased to the initial position by biasing means such as a coil spring or the like.

It is envisioned that during assembly of blade carrier 504 within housing 502, blade mount 518 is advanced along tapered section 510 of housing 502 to cause the tapered section 510 to flex outwardly and/or the blade mount 518 to flex inwardly to permit the blade mount 518 to clear internal annular ledge 514 for reception within cylindrical section 512 of housing 502. In this regard, either or both blade mount 518 and housing 502 may be formed of a resilient material.

Referring now to FIG. 8, another embodiment of the present disclosure is illustrated and is designated generally as medical apparatus 600. Medical apparatus 600 includes housing 602 defining a plurality of openings 604 of various sizes extending therethrough, and blade carrier 606 at least partially received with the housing 602. Blade carrier 606 has blade 608 (shown in cross-hatching for clarity) mounted to its lower section and extending beyond the lower surface 610 of the blade carrier 606 as shown. Blade carrier 606 is adapted for reciprocal longitudinal movement relative to housing 602 as depicted by directional arrows “J”. In FIG. 8, blade carrier 606 is depicted in an initial position with blade 608 spaced from openings 604. Blade carrier 606 is normally biased to the initial position by coil springs 612 which reside on annular internal shelf 614 within housing 602 and engage lower surface 610 of the blade carrier 606. Blade carrier 606 may be advanced within housing 602 where blade 608 traverses openings 604 to cut the medical tube or multiple tubes if desired. Movement of blade 608 is limited by internal lower surface 616 of housing 602. Blade carrier 606 may include hand grips in the form of serrated surface 618 for comfort and safety of an operator. As a further alternative, housing 602 may include recesses or channels in communication with the respective openings 604 to permit the medical tube to be introduced within a respective opening 604 without requiring threading of the medical tube through the opening 604 as discussed in connection with the embodiment of FIG. 6.

Referring now to FIGS. 9-11, there is illustrated another embodiment of the present disclosure. Medical apparatus 700 includes housing 702 defining longitudinal axis “x” and blade 704 supported within the housing 702 and mounted for movement along the longitudinal axis “x”. Housing 702 consists of front and rear covers 706, 708 respectively. Front and rear covers 706, 708 are connected to each other through suitable means. In one preferred embodiment, rear cover 708 includes peripherally located male mounting posts 710 which are received within correspondingly arranged female mounting posts (not shown) in frictional or snap relation therewith to connect the two components. Other attachment means are also envisioned including ultrasonic welding, adhesives, screws etc.

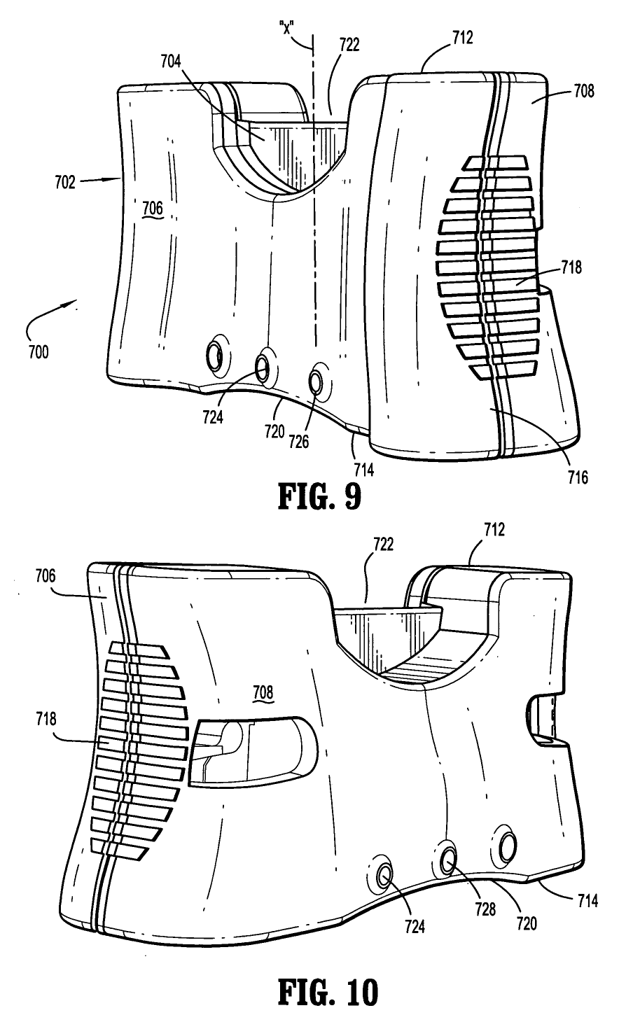

Housing 702 defines upper and lower ends or edges 712, 714 and sides 716. Housing sides 716 includes contoured surfaces 718 preferably arranged to facilitate engagement by the user. Similarly, lower end 714 includes contoured surface 720. Contoured surfaces 718, 720 include irregularities such as ribs, knurls, etc to facilitate gripping engagement by the operation. Housing 702 further includes recess 722 adjacent upper end 712. Recess 722 permits access to blade 704 to enable the operator to depress the blade 704 for actuation. Housing 702 further includes a plurality of openings 724 extending completely through the housing 704, i.e., through front and rear covers 706, 708, adjacent lower edge 714 of the housing 702. As discussed hereinabove, openings 724 have different internal dimensions or diameters for receiving correspondingly dimensioned catheter tubes. As best depicted in FIGS. 9-10, each opening 724 commences and terminates with front and rear ports 726, 728 respectively formed in front and rear covers 706, 708.

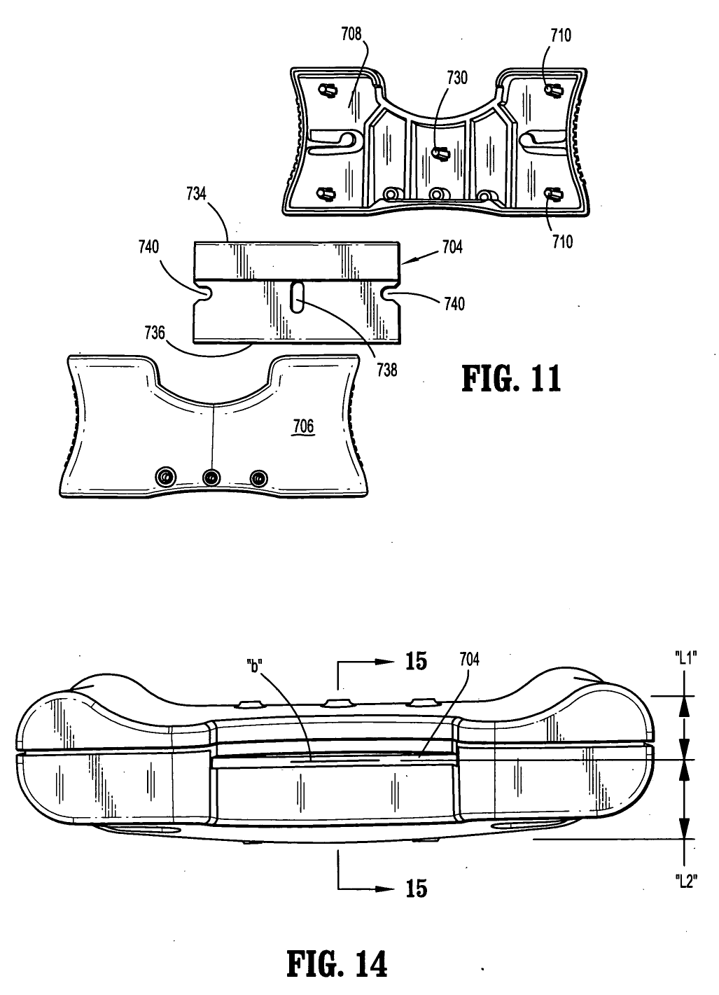

Referring now to FIGS. 11-13, rear cover 708 of housing 702 includes guide pin 730 which assists in guiding blade 704 during its longitudinal movement, and maintains the blade 704 in longitudinal alignment with the longitudinal axis “x”. Rear cover 708 further includes opposed fingers or resilient levers 732. Resilient levers 732 are disposed adjacent the perimeter of rear cover 708 and extend generally inwardly toward the longitudinal axis ”x’. Levers 732 are integrally formed with rear cover 708 and are arranged in cantilever relation. With this arrangement, levers 732 are adapted to flex downwardly, e.g., turn, rotate or pivot as shown by the directional arrow “v” (FIG. 13) along its living hinge 732a, during downward longitudinal movement of blade 704. Levers 732 are normally biased to the position shown in FIG. 11 corresponding to an initial position of blade 704. It is envisioned that levers 732 may also be separate components attached to rear cover 708 by suitable means including pivot pins, hinge means etc.

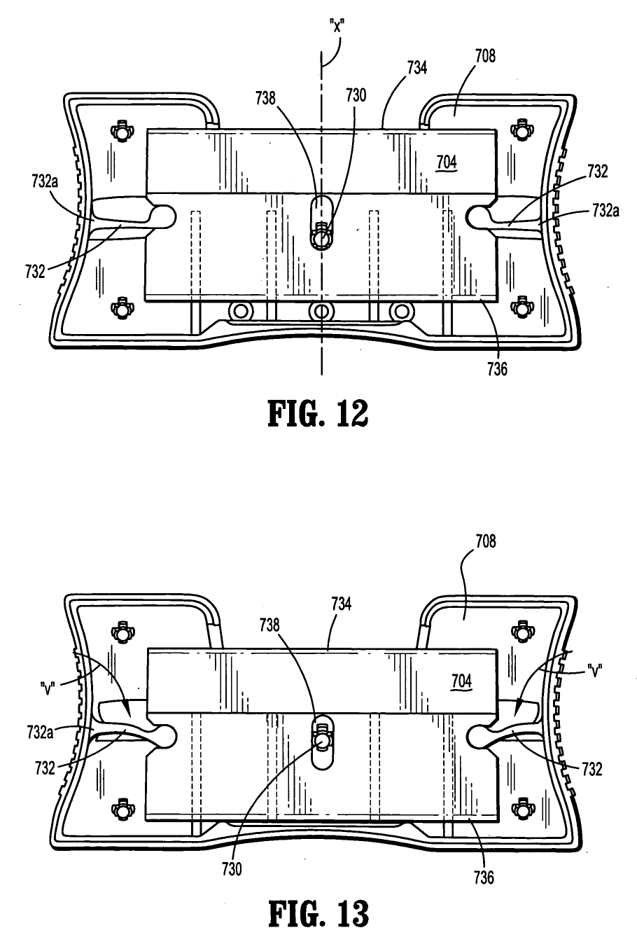

Blade 704 is preferably a planar razor blade having an upper blunt end 734 and a sharpened lower edge 736. Blade 704 is accommodated within the cavity defined within the interior of housing 702. Blade 704 includes elongated interior channel 738. Interior channel 738 receives guide pin 730 of housing 702. Guide pin 730 traverses interior channel 738 during longitudinal movement of blade 704. Blade 704 includes recesses 740 defined in opposed side edges of the blade 704. Recesses 740 are dimensioned to accommodate respective levers 732 of housing 702. Blade 704 is adapted for movement along a blade path which is parallel to longitudinal axis “x” of housing 702 from the initial position depicted in FIG. 12 to the actuated position depicted in FIG. 13. During this movement, blade 704 traverses openings 724 to cut the medical tube positioned within one of the openings 724. Simultaneously with movement of blade 704 to the actuated position of FIG. 13, levers 732 flex or pivot downwardly about their living hinges 732a opposing the normal biasing forces or resilient characteristic of the levers 732. Upon release of blade 704, the blade 704 returns to its initial position of FIG. 12 in response to the resilient biasing forces of levers 732.

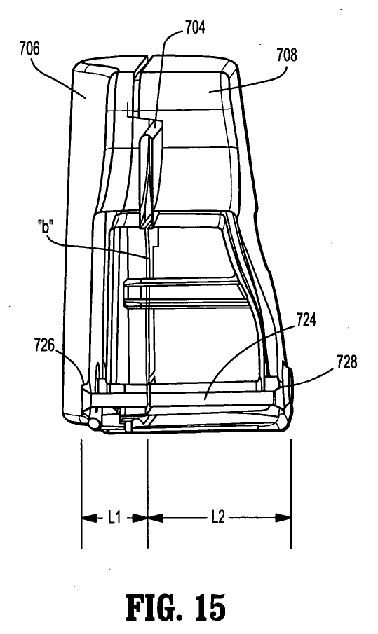

Referring now to FIG. 14-15, housing 702 is arranged to permit the operator to select or verify the precise length or depth of cut of the medical tube. In particular, the distance or length of each section of opening 724 between front port 726 of front cover 706 and blade 704 of the path of the blade 704 (blade path “b”) is preselected to a defined length “L1”. Similarly, the distance or length “L2” of each opening section between rear port 728 of rear cover 708 and the blade path is also preselected. In one preferred embodiment length “L1” is about 0.5 cm and length “L2” is about 1 cm. Thus, by virtue of these defined lengths “L1, L2”, the operator is aware of the depth of cut of the medical tube when the medical tube is positioned through either front or rear covers 706,708 of housing 202 and into one of the openings 724. Accordingly, when marking the catheter tube for cutting, the operator will need to account for an additional 0.5 cm or 1.0 cm depending on the entry approach of the medical tube with respect to housing 102. From a practical standpoint, the operator will determine the desired length of the catheter tube and locate the graduation mark on the tube or mark the exterior of the tube at a location 0.5 cm or 1.0 cm back from the desired tube length. Thereafter, the catheter tube will be introduced in one of openings 724 through front cover 706 or rear cover 708 of housing 102 and the graduation mark 0.5 cm or 1.0 cm back from the desired tube length will be aligned with the port entry location of either front or rear ports 726, 728. Actuation of blade 704 is then effected to cut the medical tube. It is noted that front and rear covers 706,708 may incorporate written indicia (“½ cm” on front cover 706 and “1 cm” on rear cover 708) to indicate to the operator the length of cut as best depicted in FIGS. 9-10.

Housing 702 of medical apparatus 700 is preferably manufactured of a polymeric material. Blade 704 may be formed of stainless steel or the like although it is envisioned that the blade 704 may be fabricated from a polymeric material as well. Medical apparatus 700 is ergonomically designed to be actuated with a single hand of the operator. For example, it is envisioned that the operator may grasp contoured surfaces 718 of housing sides 716 with the middle finger and thumb of one hand and depress blade 704 with the index finger of the same hand to cut the tube. Alternatively, the operator may grasp contoured surface 720 of lower end 714 of housing 702 with a finger and depress blade 704 with another finger of the same hand. As a further alternative, apparatus 700 may be placed on a table and actuated with a finger of the operator. Two handed actuation is also envisioned.

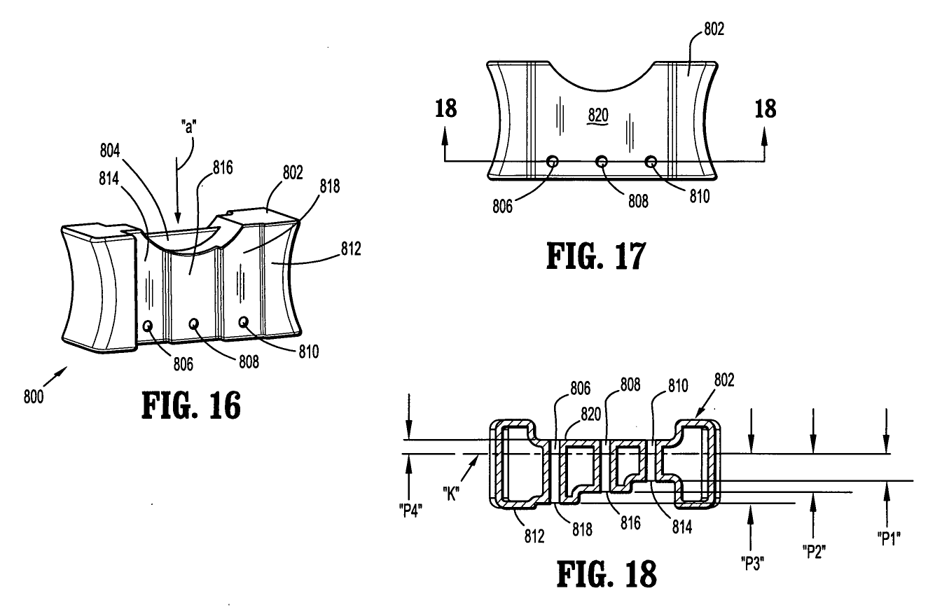

Referring now to FIGS. 16-18, there is illustrated another embodiment of the medical apparatus of the present disclosure. Medical apparatus 800 includes housing member 802 and blade member 804 mounted for reciprocal movement within the housing member 802 along longitudinal axis “a”. Blade member 804 is preferably mounted to housing member 802 in a substantially similar manner to that described hereinabove in connection with the embodiment of FIGS. 9-15. Reference is thus made to the prior discussion for details of blade member 804 and it's mounting to housing member 802.

Housing member 802 includes three openings or passages 806, 808, 810 of varying lengths extending through the housing member 802. Specifically, front face 812 of housing member 802 includes three offset or recessed surfaces 814, 816, 818 through which openings 806, 808, 810 respectively extend. Recessed surfaces 814, 816, 818 thereby provide three preselected lengths “P1”, “P2”, “P3” of openings 806,808, 810 defined between respective recessed surfaces 814, 816, 818 and the blade path “k” of blade member 804. Thus, by virtue of the predefined lengths “P1”,“P2”, “P3”, the operator is aware of the depth of cut of the medical tube when the medical tube is positioned in one of openings 806, 808, 810 via front face 812. It is also contemplated that the length between rear surface 820 and blade path “k” may be preselected to a desired length “P4” thereby giving the operator additional flexibility in cutting of the medical tube, i.e., by entry through the rear face 820 into any of the openings 806, 808, 810. In one preferred embodiment, predefined lengths “P1”, “P2”, “P3”, and “P4” may be 0.5 cm, 0.75 cm, 1.0 cm and 0.25 cm, respectively. Other lengths are also envisioned. In most other respects, medical apparatus 800 functions in a substantially similar manner to the medical apparatus 700 of FIGS. 9-15.

It will be understood that various modifications and changes in form and detail may be made to the embodiments of the present disclosure without departing from the spirit and scope of the invention. Therefore, the above description should not be construed as limiting the invention but merely as exemplifications of preferred embodiments thereof. Those skilled in the art will envision other modifications within the scope and spirit of the present invention as defined by the claims appended hereto. Having thus described the invention with the details and particularity required by the patent laws, what is claimed and desired protected is set forth in the appended claims.

What is claimed is:

1. A medical apparatus for cutting medical tubes, which comprises:
a housing member including at least one opening extending through the housing member for receiving a medical tube, the housing member defining a longitudinal axis;
a blade member mounted for longitudinal movement relative to the housing member along a blade path from an initial position to an actuated position to traverse the at least one opening and cut the medical tube received therewithin; and
a biasing member operatively engageable with the blade member and dimensioned to bias the blade member toward the initial position.

2. The medical apparatus according to claim 1 wherein the biasing member is a cantilever member, the cantilever member operatively connected to an interior of the housing member and arranged to engage the blade member in supporting relation therewith.

3. The medical apparatus according to claim 2 including first and second cantilever members extending from opposed interior surfaces of the housing member.

4. The medical apparatus according to claim 2 wherein the cantilever member in monolithically formed with the housing member.

5. The medical apparatus according to claim 1 wherein the biasing member is adapted to flex during movement of the blade member from the initial position to the actuated position.

6. The medical apparatus according to claim 1 wherein the at least one opening has a first length defined between a first side of the housing member and the blade path, and has a second different length defined between a second side of the housing member and the blade path, the first and second lengths having predetermined values to facilitate cutting of the tube to a desired tube length.

7. The medical apparatus according to claim 6 wherein the first length is about 0.5 cm and the second length is about 1.0 cm.

8. The medical apparatus according to claim 1 wherein the housing member includes contoured outer surfaces for providing handling and stability for the operator.

9. The medical apparatus according to claim 1 wherein the housing member includes a plurality of openings having different internal dimensions.

10. The medical apparatus according to claim 1 including a blade carrier, the blade carrier having the blade mounted thereto.

11. The medical apparatus according to claim 10 further comprising biasing means operatively associated with the blade carrier for biasing the blade carrier to the initial position.

12. A medical apparatus for cutting medical tubes, which comprises:
a handle;
a head depending from the handle and defining at least two openings of different internal dimensions, the at least two openings each adapted for reception of a medical tube having a corresponding cross-sectional dimension; and
a blade mounted to the head, the blade being adapted for movement relative to the at least one opening from an initial position to an approximated position upon actuation of the handle to cut a medical tube positioned within one of the at least two openings to a predetermined length.

13. The medical apparatus according to claim 12 wherein the head includes at least three openings of different internal dimensions.

14. The medical apparatus according to claim 12 wherein the handle includes first and second handle portions, the first and second handle portions adapted for relative movement to cause movement of the blade between the initial position and the approximated position.

15. The medical apparatus according to claim 14 wherein the first and second handle portions are mounted for pivotal movement.

16. The medical apparatus according to claim 14 wherein the first and second handle portions are adapted for relative longitudinal movement.

17. The medical apparatus according to claim 15 wherein the handle defines a general shear grip configuration.

18. The medical apparatus according to claim 14 wherein the first handle portion is stationary and the second handle portion is moveable relative to the first handle portion.

19. The medical apparatus according to claim 18 wherein the handle defines a general pistol grip arrangement.

20. The medical apparatus according to claim 12 further comprising biasing means operatively associated with the handle for biasing the blade towards the initial position.

21. A medical apparatus for cutting medical tubes, which comprises:
a first member including at least one opening defining an internal dimension adapted for reception of a medical tube having a generally corresponding cross-sectional dimension; and
a second member operatively connected to the first member, the second member carrying a blade member positioned to traverse the at least one opening of the first member upon relative movement of the first and second members from an initial position to an actuated position to cause the blade member to cut the medical tube to a predetermined length thereof.

22. The medical apparatus according to claim 21 wherein the first member includes at least two openings extending therethrough defining different internal dimensions, the at least two openings each adapted for reception of a medical tube having a corresponding cross-sectional dimension.

23. The medical apparatus according to claim 22 wherein the first and second members are adapted for pivotal movement between the initial position and the actuated position.

24. The medical apparatus according to claim 22 wherein the first and second members are adapted for relative longitudinal movement between the initial position and the actuated position.

25. The medical apparatus according to claim 22 wherein the at least one opening is a recess defined in an outer surface of the first member.
